(19) United States
(12) Patent Application Publication
(10) Pub. No.: US 2004/0098275 A1
(43) Pub. Date: May 20, 2004

(54) System and method for providing targeted discussion group meeting information and related items for sale

(76) Inventor: Pauline Hubert, New York, NY (US)

Correspondence Address: Jennifer Meredith, 350 Fifth Avenue Suite 7720, New York, NY, 10118, US

(21) Appl. No.: 10/295,353

(22) Filed: Nov. 15, 2002

(51) Int. Cl. G06F 17/60

(52) U.S. Cl. 705/1

(57) ABSTRACT

The present invention provides systems and methods for facilitating discussion group meetings over a network between members of the group. According to one embodiment, a method is disclosed comprising the steps of: receiving and storing in computer readable memory group information for at least one group, wherein each group has at least one member; receiving and storing in computer readable memory member information for each member; receiving and storing in computer readable memory meeting information; receiving and storing in computer readable memory a list of items for sale; and informing each member of the group of the meeting information and offering at least one targeted item for sale, wherein the targeted item for sale may be selected according to the group.

### BACKGROUND OF THE INVENTION

This invention relates generally to systems and methods for collaboration learning and information processing from a number of users regarding information about literature, where the information is based on the experiences of other people having an interest, background or profile similar to the user.

Traditionally, groups or forums (e.g. book clubs) meet periodically to discuss topics of interest (e.g. books). There may be a round table discussion, or a leader. Attendees may glean from the insight of others and realize an enhanced learning experience. Currently, people may agree to meet, may send out meeting notices via mail, email, etc., and proceed to find a location in which to meet. Any changes may require a good deal of phoning, emailing, etc. Also, providing pre-meeting information may be cumbersome. Another difficulty lies is that such clubs may be difficult for attendees to always attend. Today's busy society may make attendance increasingly difficult. As such, it would be desirable to provide pre-meeting information, so that attendees may choose whether they have an interest in attending, or would prefer to attend the next meeting.

Computer networks, such as the Internet, have dramatically changed the way the people communicate with each other and get information about topics that interest them. Tools such as electronic mail (e-mail) and instant messaging are rapidly eclipsing conventional printed and mailed communications, and on-line versions of publications such as newspapers and magazines expand the availability of information previously available only to a few. The Internet is also allowing collaboration and providing information (and ways of getting it) that has few equivalents in the non-Internet world. For example, search engines such as Yahoo and Lycos enable users to rapidly and instantly get huge quantities of information and data about virtually any topic of interest, such as travel destinations, a favorite entertainer, a potential employer, and the like. Other sources of information on the Internet include bulletin boards, chat groups, and newsgroups such as USENET. These latter information sources give everyone with access to the Internet a way to “speak out” to a virtually unlimited audience at any time and at little or no cost, providing useful information, wisdom, tips, tricks, questions and answers, running commentary, criticism, anecdotes, and more, directly from Internet users, on virtually any and every topic.

To access the information in newsgroups such as USENET, sites such as www.altavista.com and www.deja.com provide search engines enabling users to search for posts directly related to specific topics. For example, a user can search a group such to view posts related to a topic such as “Jonathan Franzen.” This may turn up a great deal of information regarding the author, and topics of interest to readers. Although it is sometimes possible to find information directly on topic, posted by legitimate readers, one often has to sift through thousands of messages related to a given topic, reading each one, to determine if a post has personal relevance to a user or group. Another disadvantage is the prevalence of SPAM (unsolicited commercial email messages) and other advertisements disguised as “genuine” posts to such groups. Consequently, newsgroups are not a convenient or, more importantly, relevant source of information for many consumers, particularly those looking for information regarding books.

Online forums, though, have been lacking in that the information is difficult to sift through, may not be targeted and may not provide many of the benefits that face to face interaction can. Also, many members enjoy human interaction, and the feeling of belonging to a group where they know the members personally. Offline book clubs have served the purposes of providing a forum for individuals to get together, discussing and learning from one another, and providing an environment to meet others sharing a common interest. Heretofore, there has not been a forum for combining both online and offline discussion groups in a manner that furthers both forums. For instance, in today's busy society it is desirable to provide a forum where people can find others interested in the same thing (e.g. 14^{th} century literature), where they can chose to either attend the meeting or virtually offer input where the user may be too busy to physically show up for a meeting. Also, previous online forums have lacked the ability to allow potential attendees a way to pre-screen whether they have an interest in a club. For instance, some attendees may feel they are not intelligent enough (or are too intelligent) for certain groups and attending a meeting would not be fruitful. Allowing a potential attendee to pre-screen book club, without attending may provide beneficial to the members of the group and prospective members.

Also, previous systems and methods do not provide for efficient inter-group communication among similar interest groups, offer items for sale related to upcoming meetings, provide suggestions based upon group membership, and allow members of a group to communicate with other groups. Accordingly, there is a need within the prior art to provide a system and method for facilitating physical meetings, pre-meeting topics, inter-group communication and discussion, where individuals may RSVP and items of interest may be offered for sale easily and in response to a single action.

### SUMMARY OF THE INVENTION

It is envisioned that the present invention may be utilized as a stand alone system, website, or a portion of a website. According to one aspect of the present invention, a system for providing meeting planning services for multiple members of a group via a communications network is disclosed comprising: a member module for collecting and storing member information; a group module for collecting and storing group information relating to the group; a meeting module for collecting and displaying meeting information relating to future meetings and providing inter-group member communication; a item module for collecting and storing item information; and a member interface for mediating communications via the communication network between the members of the group and providing information from the member module, group module, meeting module and item module to provide a list of targeted items for sale to members.

According to a further aspect of the present invention, a system for facilitating discussion group meetings over a network is disclosed comprising: a computer readable memory storing at least one group with associated group information, at least one meeting item and member information for at least one member for each group, wherein at least one member has selected a group and the computer readable memory provides a discussion forum, presents at least a portion of group information and at least one meeting item to the member, automatically emails each member of a group with information regarding at least one meeting item for the group upon addition of a meeting item to the computer readable memory and offers a targeted item for sale to the member.

According to another embodiment, a method for facilitating discussion group meetings over a network between members of the group, the method comprising the steps of: receiving and storing in computer readable memory group information for at least one group, wherein each group has at least one member; receiving and storing in computer readable memory member information for each at least one member; receiving and storing in computer readable memory meeting information; receiving and storing in computer readable memory a list of items for sale; and informing each member of a group meeting information and offering at least one targeted item for sale, wherein the targeted item for sale is selected according to said group.

According to another embodiment, a method for facilitating on and offline discussion group meetings over a network between members of the group is disclosed comprising the steps of: receiving and storing in a computer readable memory group information for at least one group; receiving and storing in computer readable memory member information from at least one member; providing each member with a list of groups from computer readable memory; receiving and storing in computer readable memory a group selection from a member; providing a list of membership plans to said member, wherein the membership plans are scaled; receiving and storing in computer readable memory a membership selection for each member; receiving and storing in computer readable memory meeting information; receiving and storing in computer readable memory a list of items for sale; categorizing each item in the list of items to provide a list of categories for each item; informing each member of a group of meeting information and offering at least one targeted item for sale, wherein the targeted item for sale is selected according to the group and the list of categories and may be purchased in response to a single action; and providing an online discussion forum.

These and other features, aspects and advantages of the present invention will become better understood with reference to the following drawings, description and claims.

### BRIEF DESCRIPTION OF THE DRAWINGS

FIG. 1 depicts a system according to an embodiment of the present invention;

FIG. 2 depicts a flowchart according to an embodiment of the present invention;

FIG. 3 depicts a screenshot of a form used according to an embodiment of the present invention;

FIG. 4 depicts a screenshot of a form used according to an embodiment of the present invention;

FIG. 5 depicts a screenshot of a form used according to an embodiment of the present invention;

FIG. 6 depicts a screenshot of a form used according to an embodiment of the present invention;

FIG. 7 depicts a screenshot of a form used according to an embodiment of the present invention;

FIG. 8 depicts a screenshot of an email according to an embodiment of the present invention;

FIG. 9 depicts a screenshot of a group page according to an embodiment of the present invention;

FIG. 10 depicts a methodology according to an embodiment of the present invention; and

FIGS. 11a-11k depict an overview of an embodiment according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

It is envisioned that the present invention provide systems and methods for facilitating discussion group meetings over a network between member of the group. Such systems and methods are particularly well adapted, by way of example, to book clubs and the like. It should be noted, that security measures as known within the art are intended throughout the systems and methods disclosed herein. This may include SSL and login measures at various points.

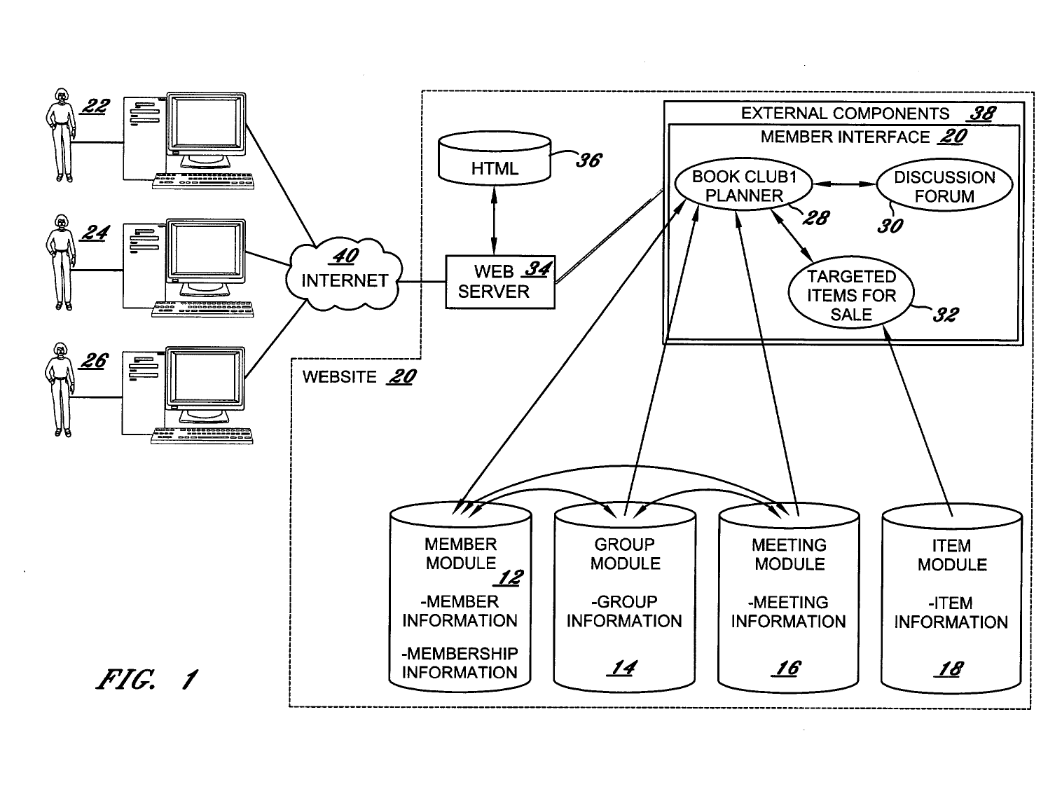

FIG. 1 depicts a system for providing meeting planning services for multiple members of a group via a communications network according to one aspect of the present invention. The system is comprised of a member module 12 for collecting and storing member information. The system has a member module 12 for collecting and storing member information, a group module 14 for collecting and storing group information relating to the group, a meeting module 16 for collecting and displaying meeting information relating to future meetings and providing inter-group member communication, and an item module 18 for collecting and storing item information. There is also a member interface 20 for mediating communications via the communication network between the members (e.g. 22, 24, 26) of the group and providing information from the member module 12, the group module 14, the meeting module 16 and the item module 18 to provide a list of targeted items for sale to members (e.g. 22, 24, 26). Information may be exchanged or shared between the member module 12, group module 14, meeting module 16 and item module 18. Each module may even be a contained within a larger single module or database, without limitation.

The meeting module 16 contains information regarding individual members (e.g. 22, 24, 26) such as first name, last name, email address, mailing address, city, town, state, province, zip code, telephone, birthday, make administrative contact, credit card info, contact information, and membership information. The group module 14 contains group information such as group name, city, town, state, province, meeting since date, meeting location, relation of members, meeting frequency, who leads, genre, topic, last book read, desired reading topics. The meeting module 16 contains meeting information such as location, time, date, book selection, discussion topics. The item module 18 contains item information such as name, price, genre, author, etc. Depending on the item being presented, the item information may vary.

It is intended that the member interface 20, provide a forum for members with similar interest to communicate, and also to provide ease for members to purchase items of interest or related to upcoming meetings. For example, where the group is a book club, it is desirable to provide a book club planner 28. The book club planner 28 may update members of the place, date, time, attendance, discussion topics and the like for upcoming meetings. There may also be a discussion forum 30, where members (e.g. 22, 24, 26) may post topics of interest. All the members may be reading the same book and comments on a particular portion of the book, or other books that may be of interest. It is also intended that the member interface 20 provide targeted items for sale 32 to the members (e.g. 22, 24, 26). By way of example, the targeted item may be the book that the book club is reading. The targeted item may also be a movie made from the book that they are reading, electronic books, movies, DVD's, compact disc's or any other item for which groups may meet to discuss or which may be particularly relevant to a discussion group. The member interface 20 may also include public and private discussion boards. The private discussion board may be viewable only to members of the club. The public discussion board may viewable to anyone at the website. There may also be an inter-group discussion board, which is only viewable by people who are a member of at least one group.

One of the reasons people may join similar interest clubs is to glean such knowledge and guidance from others members and outside influences. The item module may contain information regarding items, such that if a member likes one item, a similar item would be a good recommendation. For example, where a reader liked Tom Wolfe's “A Man in Full”, it may be wise to offer Tom Wolfe's “Bonfire of the Vanities” or a Nelson Demille novel.

The web server 34 may communicate with various external components 38. This may include a search engine and associated databases for enabling users to search for particular items, processing components allowing for the purchase of targeted items for sale 32, shopping carts, item information catalogs, related group webpages, and webpages of interest. The website 20 includes a web server 34 which access a database 36 of HTML (hypertext markup language) content which includes information regarding the group, targeted items for sale, upcoming meetings, discussion forums and other items of interest, such as author inspired discussion questions.

The present invention also envisions a system for facilitating discussion group meetings over a network. The system comprising a computer readable memory storing at least one group with associated group information, at least one meeting item and member information for at least one member for each group. The member has selected a group and the computer readable memory provides a discussion forum, presents at least a portion of group information and at least one meeting item to the member. The computer readable memory also automatically emails each member of a the group with information regarding at least one meeting item for the group upon addition of the meeting item to the computer readable memory and offers a targeted item for sale to the member. According to a preferred embodiment, the group is a book club. Meeting items may include many different items of information such as location, time, date, book selection, discussion topics. Member information may also include a great deal of variation but may include first name, last name, email address, mailing address, city, town, state, province, zip code, country, make administrative contact, credit card information, telephone, birthday, membership information and attendance status. Group information may include name, city, town, state, province, meeting since date, meeting location, relation of member, meeting frequency, who leads, genre, topic, last book read, desired reading topics. The targeted item for sale may a book, electronic book, movie, DVD and compact disc. More specifically, the targeted item for sale may be the book chosen as a book club selection.

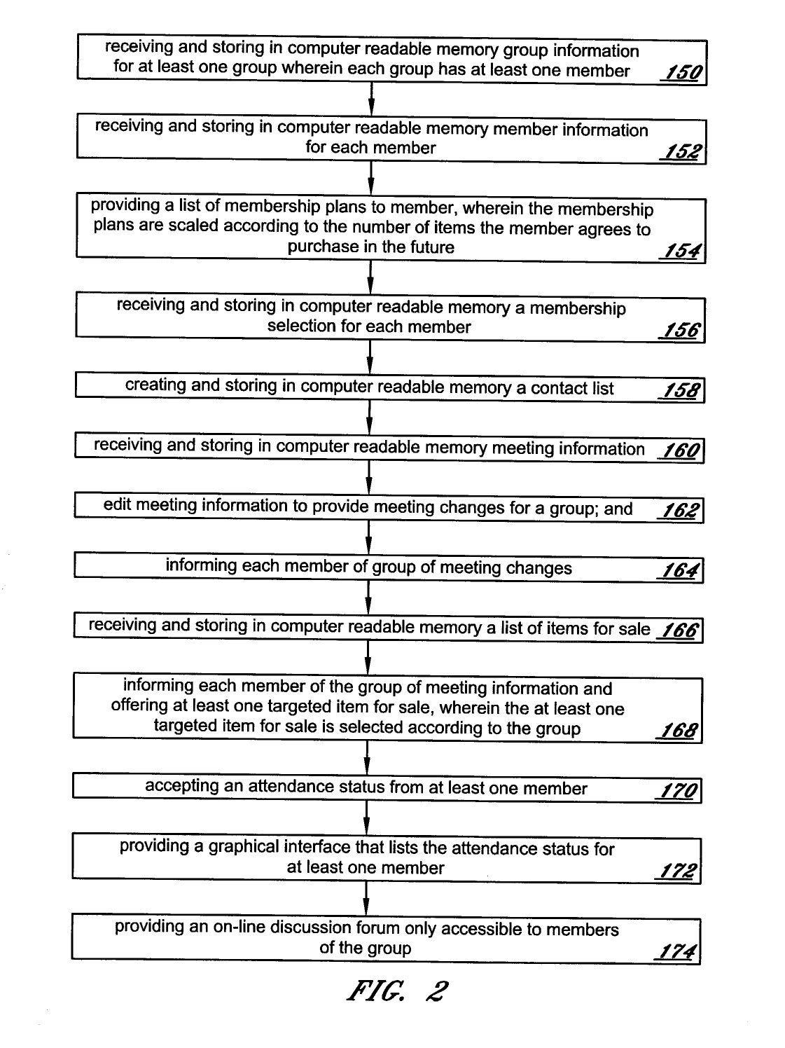

According to a preferred embodiment, a method for facilitating discussion group meetings over a network between members of the group is disclosed. FIG. 2 depicts a flowchart of the method according to a preferred embodiment. The method comprising step 150 receiving and storing in computer readable memory group information for at least one group, wherein each group has at least one member; step 152 receiving and storing in computer readable memory member information for each member; step 154 providing a list of membership plans to the member, wherein the membership plans are scaled; step 156 receiving and storing in computer readable memory a membership selection for each said at least one member; step 158 creating and storing in computer readable memory a contact list; step 160 receiving and storing in computer readable memory meeting information; step 162 editing the meeting information to provide meeting changes for a group; step 166 receiving and storing in computer readable memory a list of items for sale; step 168 informing each member of the group of meeting information and offering at least one targeted item for sale, wherein at least one targeted item for sale is selected according to said group; step 170 accepting an attendance status from at least one member; step 172 providing a graphical interface that lists the attendance status for at least one member; step 174 providing an online discussion forum. The discussion forum may be public and private discussion boards. The private discussion board may be viewable only to members of the club. The public discussion board may viewable to anyone at the website. There may also be an inter-group discussion board, which is only viewable by people who are a member of at least one group.

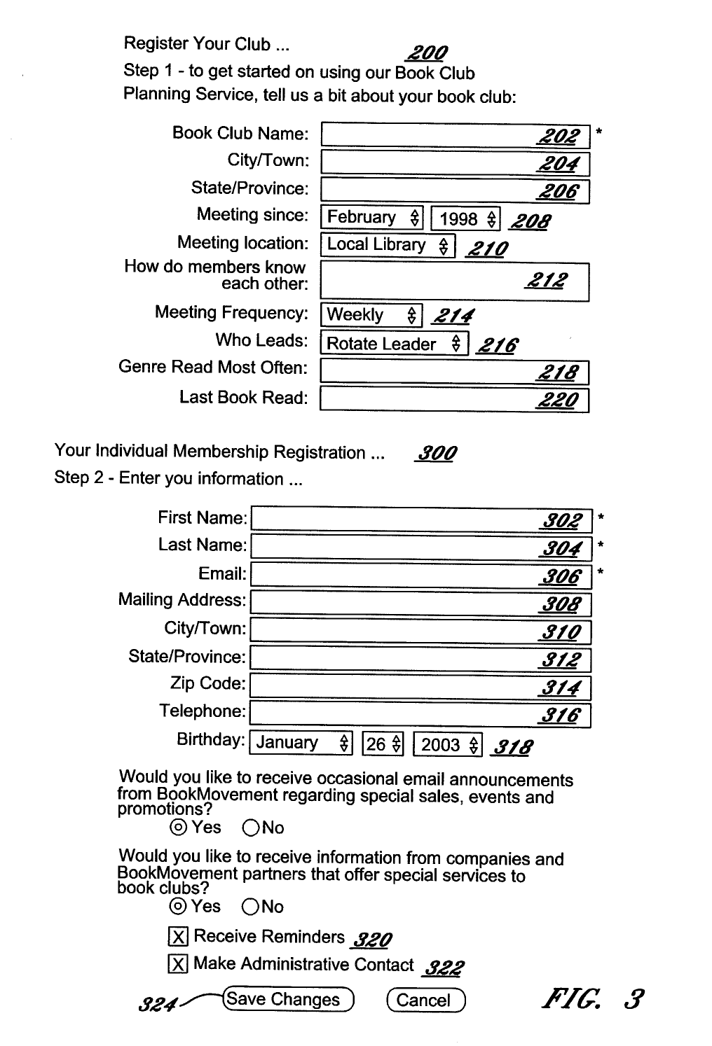

Referring now to FIGS. 2-9 together, FIG. 3 depicts an example of the manner in which step 150 receiving and storing in computer readable memory may be implemented. As shown, a form 200 may accept group information such as book club name 202, city/town 204, state/province 206, meeting since date 208, meeting location 210, relation of members or how do member know each other 212, meeting frequency 214, leader 216, genre read most often 218, last book read 220.

FIG. 3 depicts a manner in which step 152 receiving and storing in computer readable memory member information for each said at least one member may be accomplished. As shown, form 300 may be used to receive and store information (which may be stored in a database, such as member module 12) for each member (e.g. 22, 24, 25). The form 300 include spaces to receive and storing member information including the first name 302, last name 304, email 306, mailing address 308, city/town 310, state/province 312, zip code 314, telephone 316, and birthday 318. Also, member information may include information relating to updates 320 and whether the member is also an administrative contact 322. Information may be stored by clicking on the save changes 324 button.

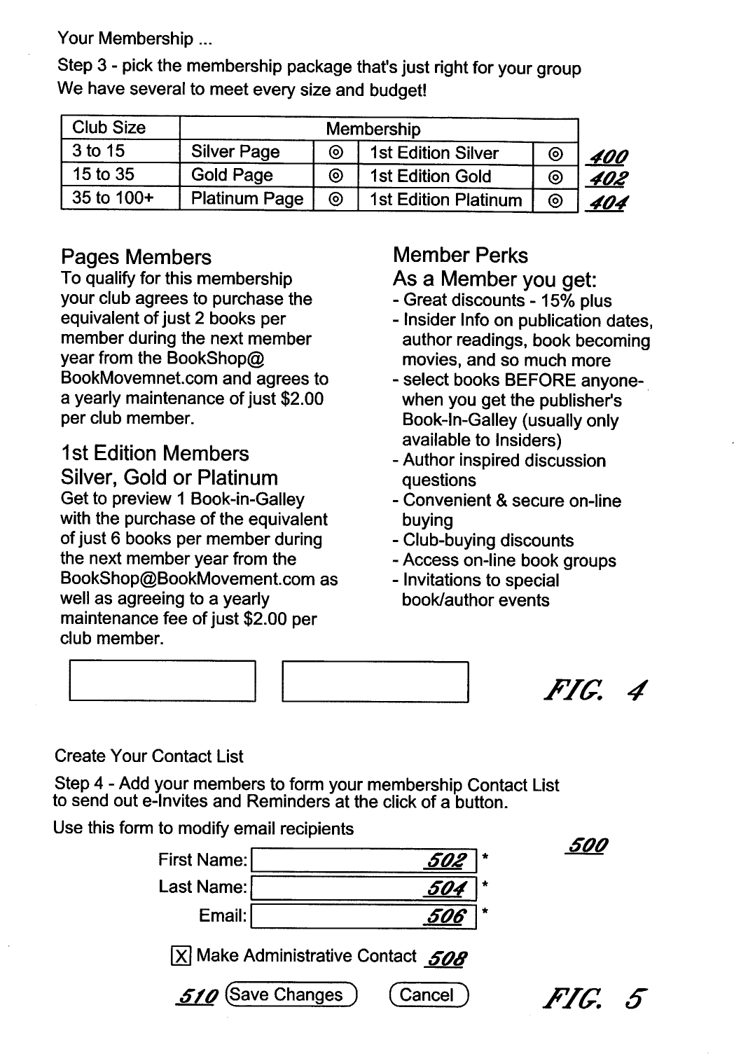

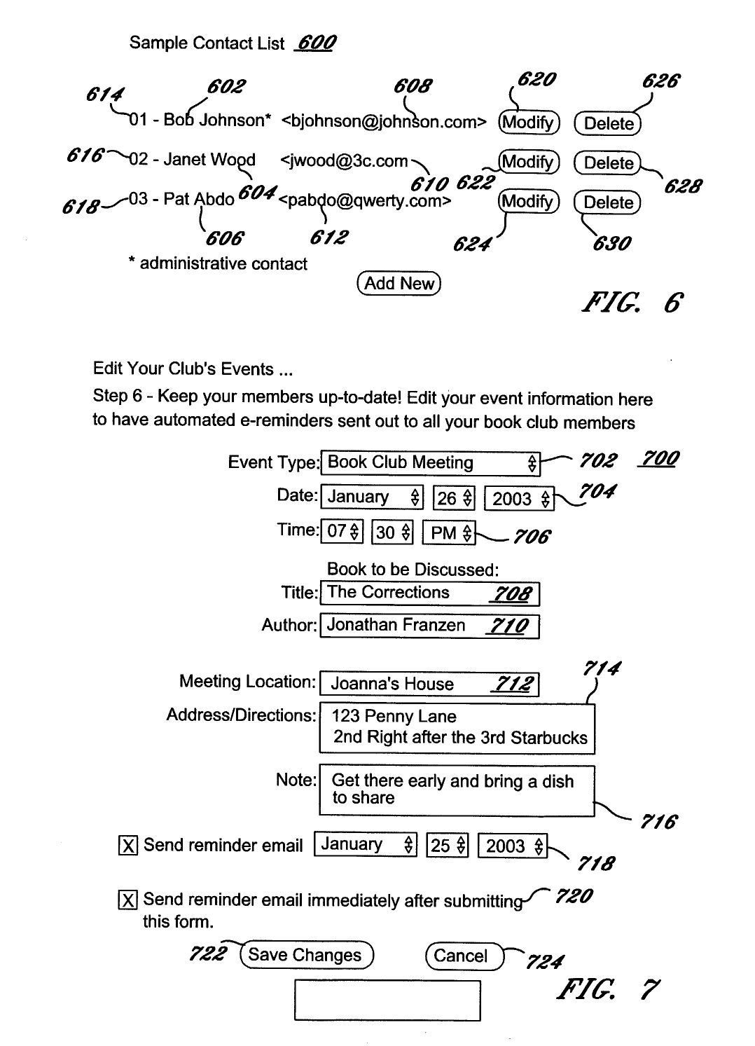

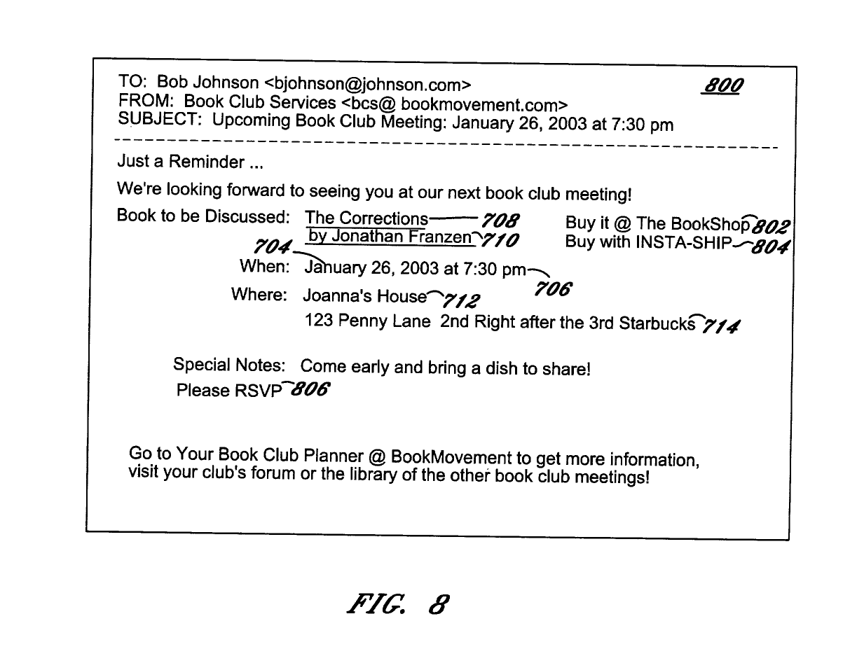

FIG. 4 depicts a screen shot of step 154 providing a list of membership plans, such as silver 400, gold 402, platinum 404, to a member. The membership plans may be scaled according to the number of members or the items the member agrees to purchase in the future. It is envisioned that the fees may be scaled in a number of different ways. By way of example, though, an individual book club member may pay $14.95 one-time set-up fee, agree to purchase two books per year and pay a yearly maintenance of $9.95. If the member, though, agrees to purchase 6 books a year, one time fee would be reduced, and they would pay yearly maintenance of $5.95/year. Also, where a member belongs to more than one group, the fees may be reduced. For example, the second book club may be $6.95 initial set-up, require two books/year and have a yearly annual maintenance of $2.95. Libraries, schools, and perhaps independent bookstores may be charged according to a different scale. For instance, if they sign up 1-10 groups, there would be a $15.95 setup fee and annual maintenance of $10.95. For 10-20 groups, there would be a $19.95 set-up fee and annual maintenance of $7.95. The membership may also be scaled according to the number of members, as shown in FIG. 4, silver 400 memberships provides a membership for a group consisting of 3 to 15 members, gold 402 memberships provides membership for a group consisting of 5 to 35 members, and platinum 404 memberships provides membership for a group consisting of 35 to 100 members. Upon selecting a membership, the membership selected is received and stored in computer readable memory. It should be understood that individual's members may sign up, and/or one member may sign up the entire group.

Where one member signs up the group, they may want to create a contact list of the other members as in step 158. FIG. 5 depicts a form 500 for creating a contact list. As shown, the first name 502, last name 504 and email 506 of other members may be input. Also, one member or more may be granted administrative privileges by checking the make administrative contact box 508. Information contained within the form 500 is stored upon clicking the save changes 510 button. The system, according to the present invention, will create a contact list 600, as shown in FIG. 6. By way of example, this may list the name of members (e.g. 602, 604, 606) and associated emails (e.g. 608, 610, 612). Also, identifiers (e.g. 614, 616, 618) may be associated with members (e.g. 602, 604, 606). Information contained within the contact list 600 may be modified by clicking button 620, 622, 624 or deleted by clicking 626, 628, 630.

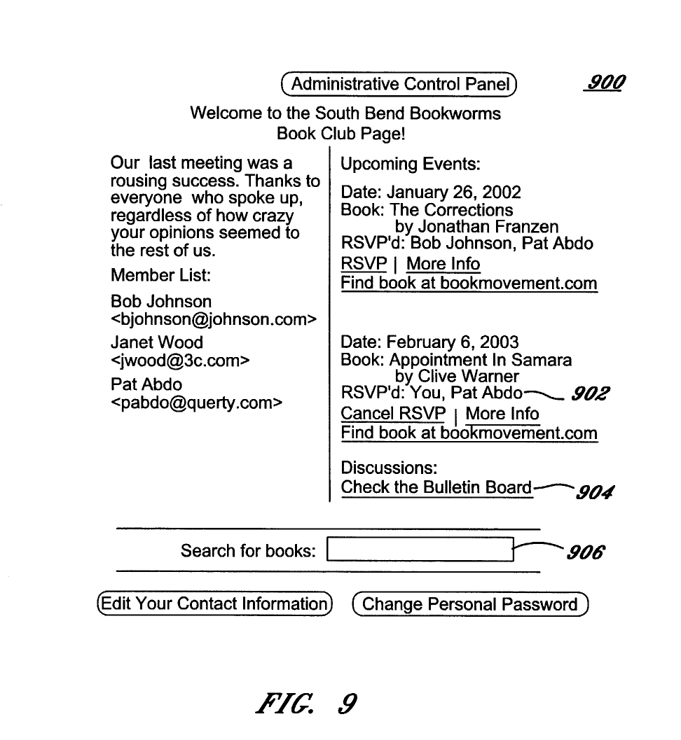

A manner in which step 160 receiving and storing in computer readable memory meeting information is accomplished is shown in FIG. 7. Form 700 accepts meeting information such as the event type 702, date 704, time 706, title 708, author 710, meeting location 712, address directions, 714, notes 716, email reminders 718, automatic emailing options 720. Step 162 editing said meeting information to provide meeting changes for a group may utilize the same form 700. Where changes are to be effectuated, the member filling the form 700 may click 722. In this way, changes may be automatically emailed to all the members of the group, and changes updated to the website.

Step 166 receiving and storing in computer readable memory a list of items may be accomplished in a number of ways. This information may be manually input by any individual (authors, members, salespeople, etc.). For example, the administrative contact may input an upcoming book selection, which becomes the targeted item offered for sale to members. Also, item information may be imported from a separate database to provide a wide range of items available to members.

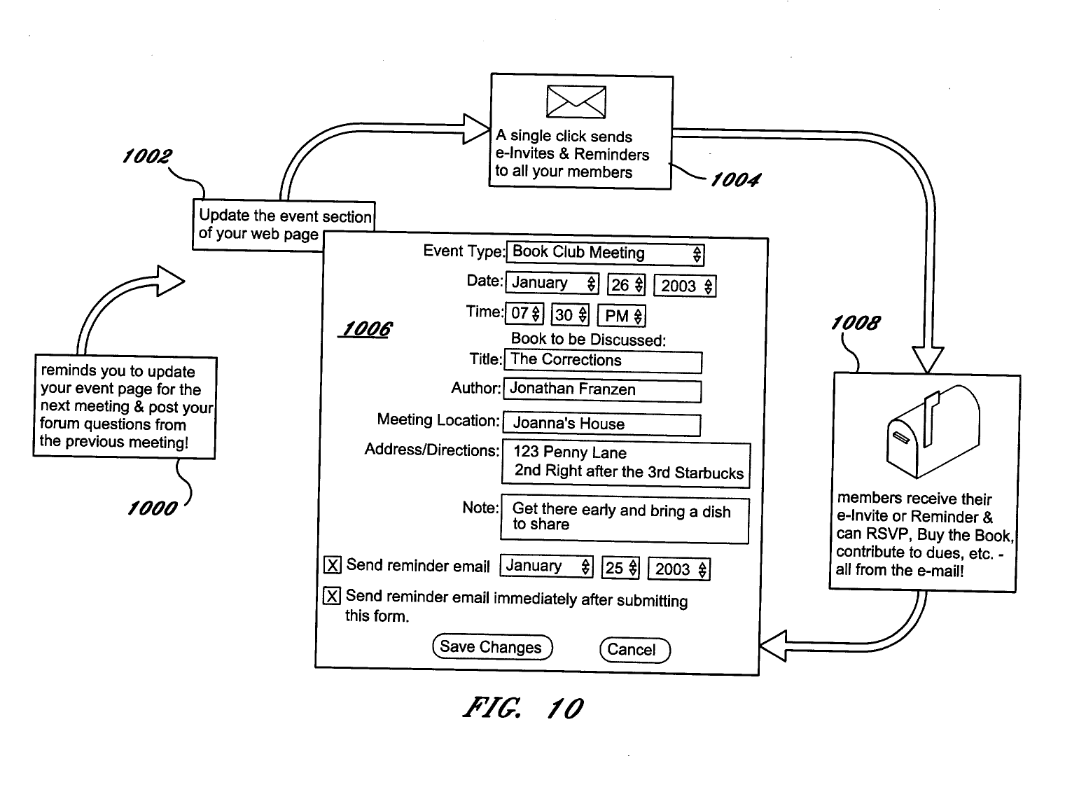

FIG. 8 depicts an example of an automatically generated email 800. This is one manner in which step 168 informing each member of the group of information and offering at least one targeted item for sale may be implemented. As shown, the email 800 provides a reminder with meeting information. It may include meeting information such as title 708, author 710, date 704, time 706, meeting location 712, address directions 714 and any other relevant information. As shown, the targeted item offered for sale 802 is the book that will discussed at the upcoming meeting on a given date 704. In this way, members are easily informed of information relating to the upcoming meeting, and offered the book that they may want to purchase for the meeting. Previously stored member information may be used to allow the member to obtain the item with a single action, namely, clicking on the INSTA-Ship 804 button. Where the member has clicked on, or selected, the INSTA-Ship 804 button, this information may be received and previously stored member information required to purchase the item retrieved. This may include credit card information obtained from the member at the time of initial sign-up. This results in a generated order, which will be fulfilled to provide a purchased item, which is then delivered to the member. Optionally, a confirmation email may be sent to the member. In this manner, targeted items are offered for sale, and members and sellers of these items may fulfill these orders easily.

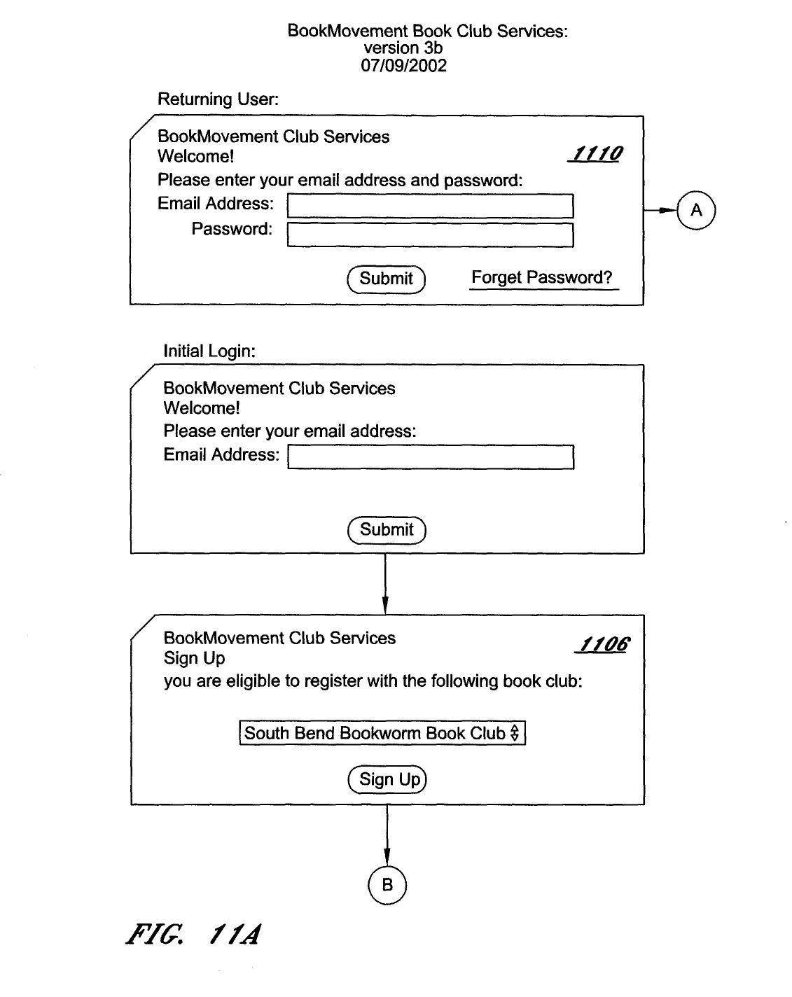

Within the same email 800, there may be a manner in which step 170 accepting an attendance status from at least one member can also be fulfilled. For example, the member may click on the Please RSVP 806 button. The member may either accept or decline. FIG. 9 depicts a manner in which step 172 providing a graphical interface that lists the attendance status for at least one member and step 174 providing an online discussion forum only accessible to members of the group may be fulfilled. As stated previously, there may be many different types of discussion boards. Some may be publicly viewable, some viewable only to members the group, and some only view to people who are members of at least one group. Where the member has accepted the RSVP 806 (also referred to as attendance status), they will be listed as RSVP'd 902. It is intended that the group page 900 be viewable to members and potential members. It may be linked to any of the previously mentioned forms or pages. Also, it is envisioned, that there are a number of group pages and the groups may share information regarding topics, ideas, suggestions, etc. Inter-group communication is generally shared on a page separate from the group page, such as an inter-group discussion board. It should be understood, that there may be both group discussion boards, only visible to those members of the group and inter-group discussion boards which may be visible to the public or those individuals signed up as members of at least one group. The group page 900 also has a link to a discussion board 904 where members can discuss topics of interest, updates, etc. Targeted items may also be offered for sale at the group page 900. Also, it is intended that the member may search 906 for any item or targeted item they desire.

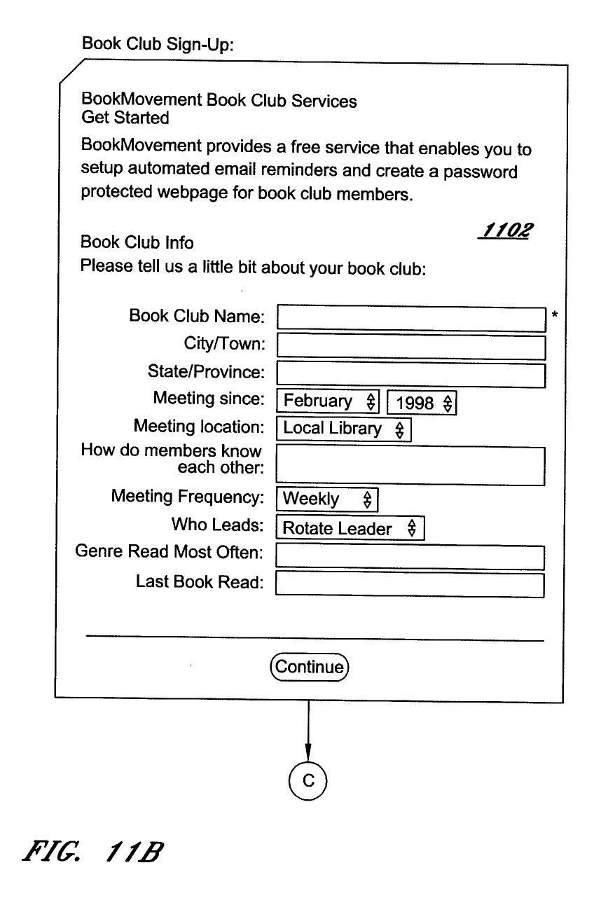

It is a purpose of the present invention to facilitate and streamline the process of group meetings, as shown in FIG. 10. Each time meeting information is edited, updated or changed, automatically generated emails may be sent to members on the contact list. The group and webpage 1006 is then automatically updated 1002, emails containing meeting information and reminders may be sent to all members 1004, and members can RSVP or input their attendance status 1008 and purchase targeted items with a single action 1006. Where members RSVP, this too will automatically update the group webpage 1006 to provide an accepted attendance status for the member. After the date of a meeting has gone out, an automatically generated email 1000 reminds you to update your meeting information for the next meeting and post forum questions from the previous meeting.

The present invention also envisions providing targeted incentive to its members. This may include discounts, information, publication dates, author readings, books becoming movies, pre-publications books, author inspired discussion questions, group buying discounts.

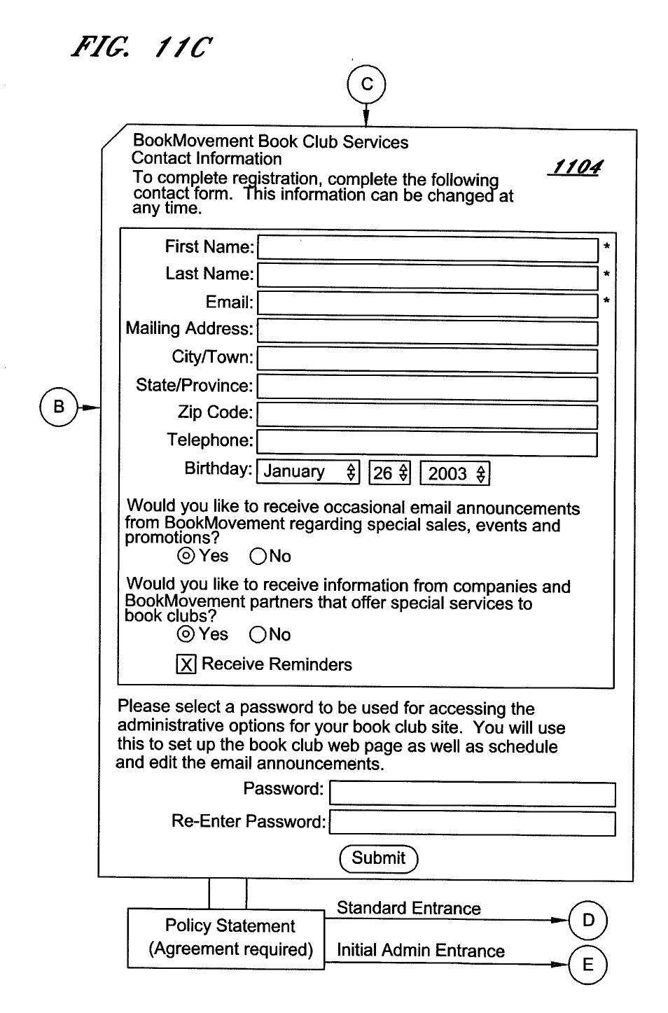

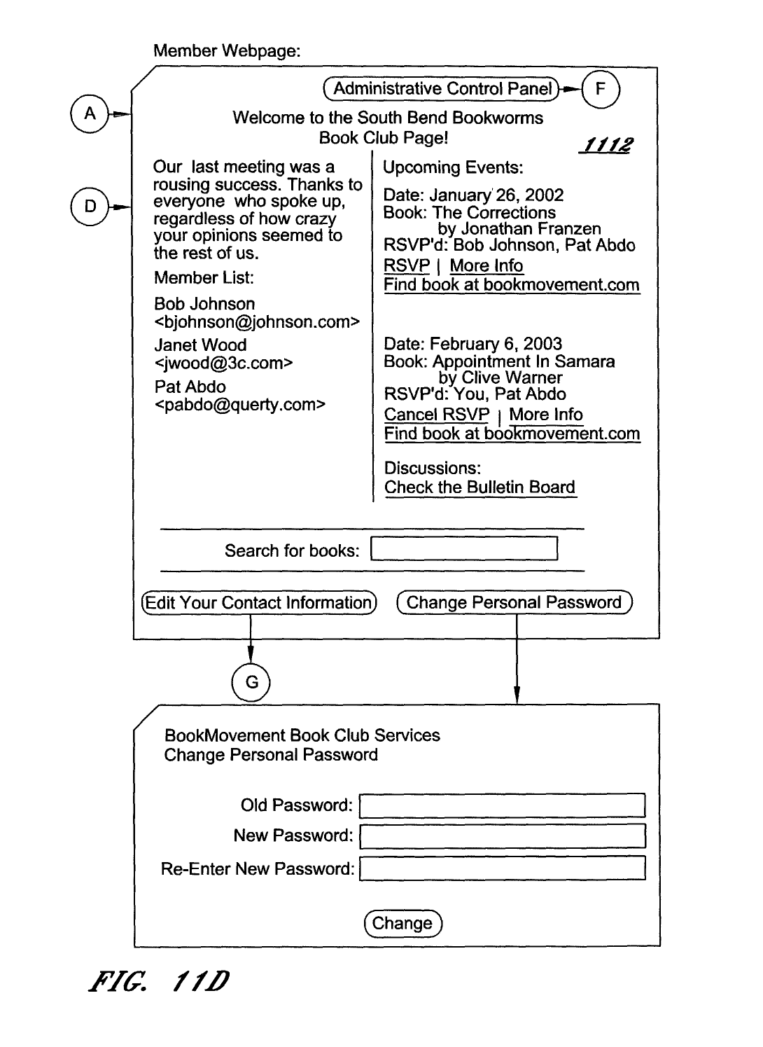

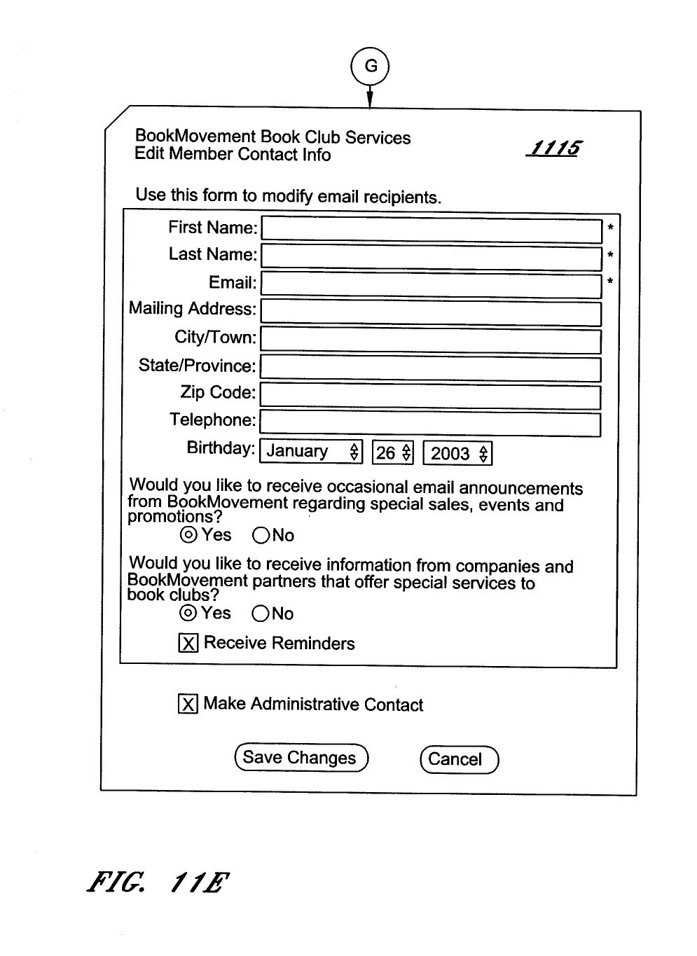

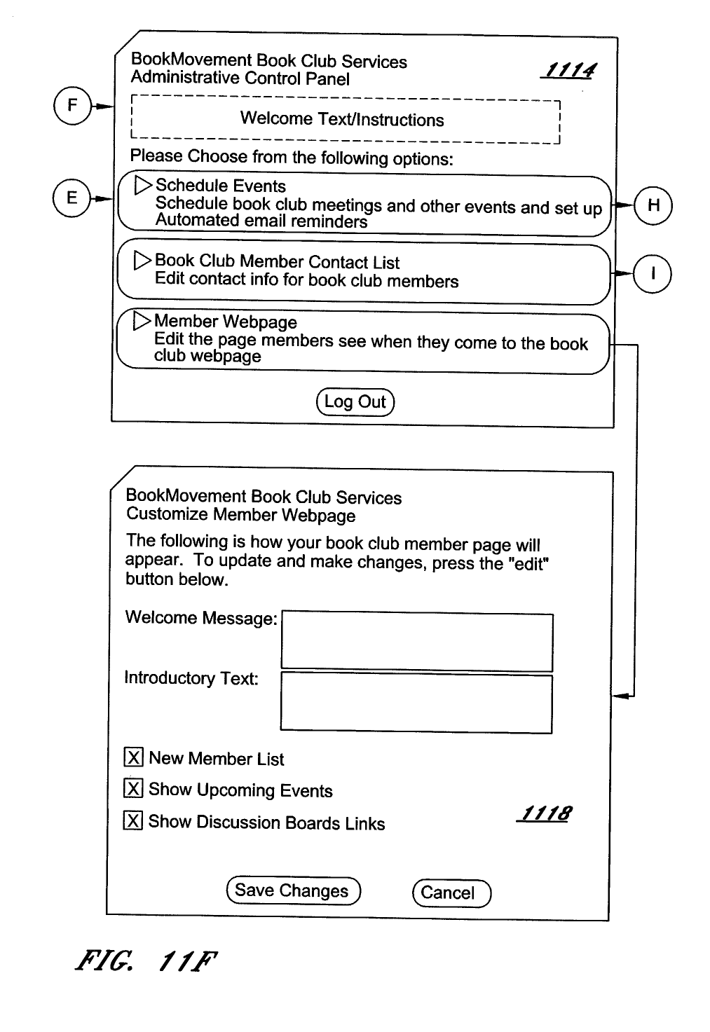

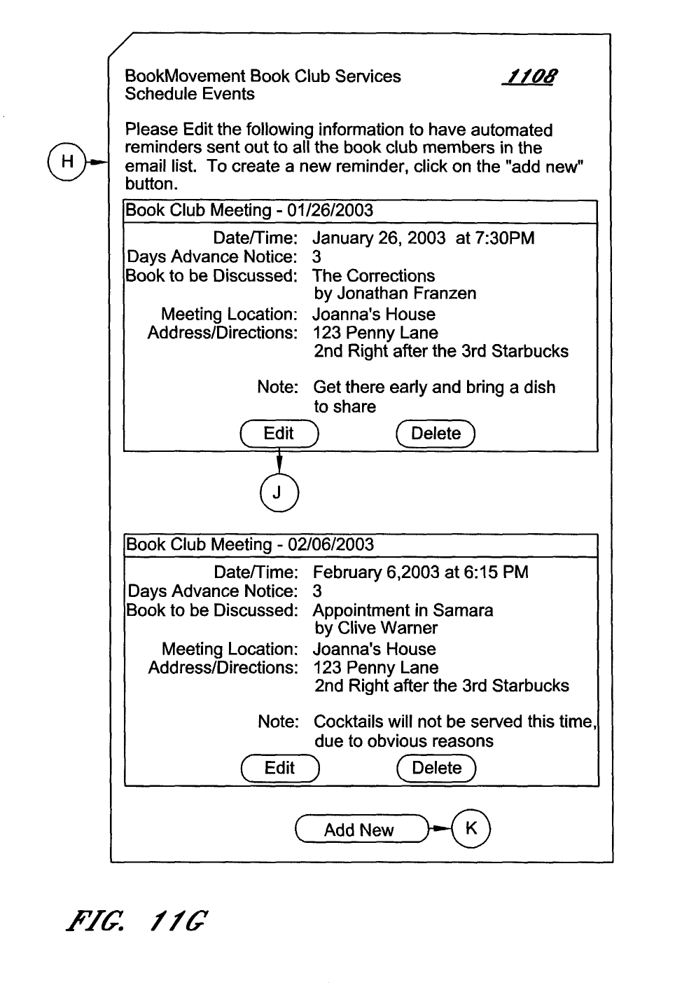

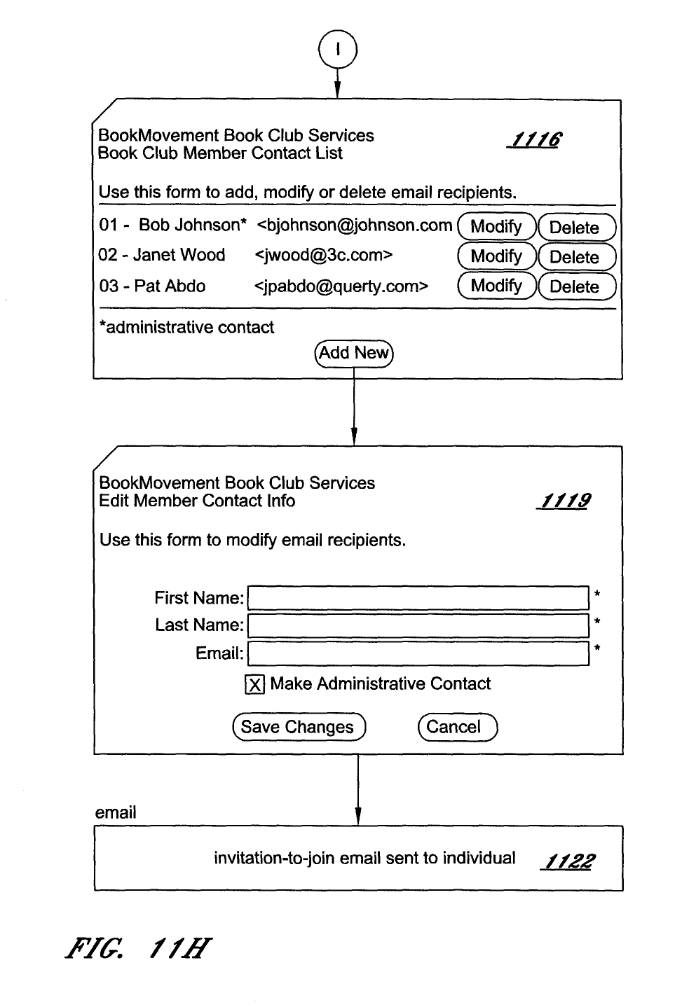

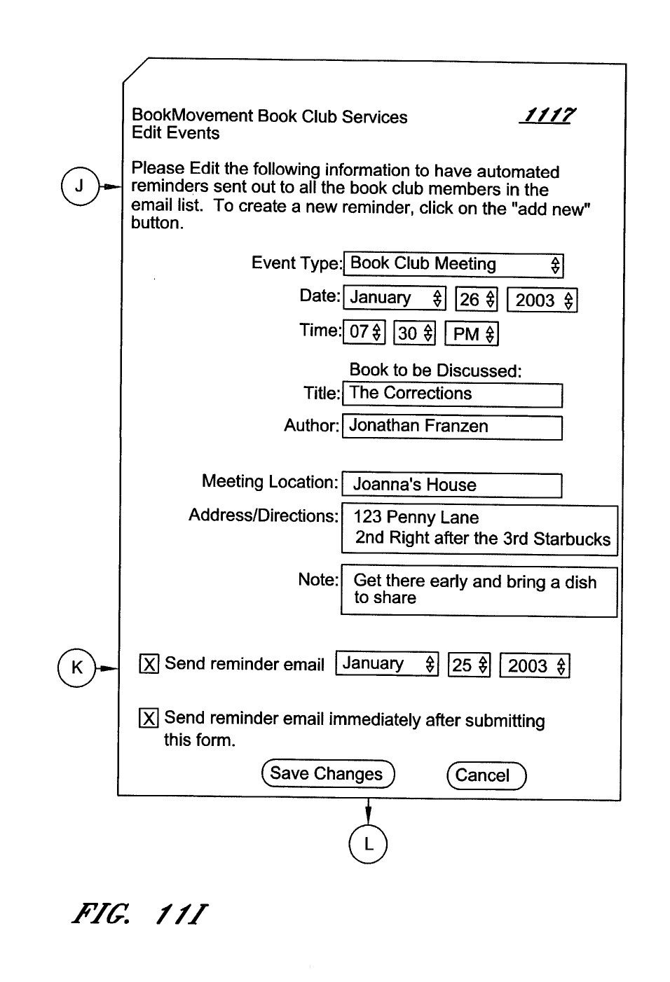

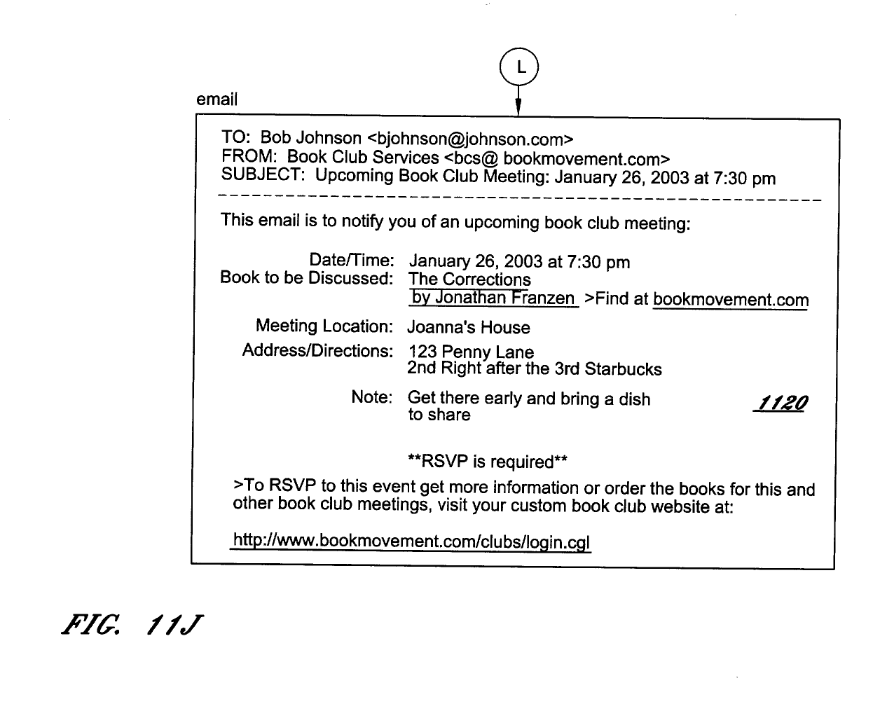

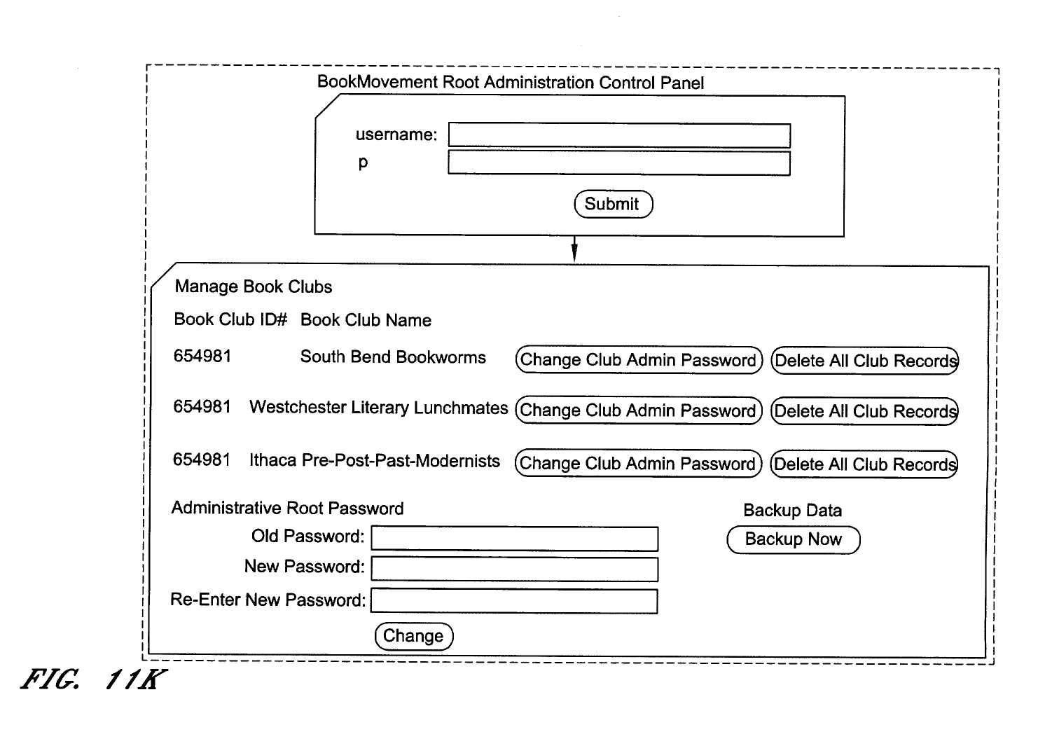

FIGS. 11a-11k are intended to be viewed together and depict an overall methodology as in the present invention. Depicted is a method for facilitating on and offline discussion group meetings over a network between members of the group. The first step may be receiving and storing in a computer readable memory group information for at least one group as shown in FIG. 11b, screen shot 1102. It should be understood, that the present invention may be used by those members who want to enroll their group and members looking to join an already created group. Next, FIG. 11c, screen shot 1104 depicts a manner in which receiving and storing in computer readable memory member information from at least one member. This is intended to be the initial set-up. Where the member is looking to join an already formed group, a list of groups from computer readable memory as depicted in FIG. 11a, screen shot 1106 may be provided to the member. The member may then select a group. The member may also input a contact list containing emails for members of the group, and an automatically generated email may be sent to each email on the contact list, inviting them to join. The system then receives and stores the group selection from the member. As discussed previously, a list of membership plans may be supplied to the member, which may be scaled according to the number of books they plan to purchase and type of group. Where the member selects a membership plan, this is received and stored in computer readable memory. It should be noted that the terms users and members are interchangeable. For returning members, member information may consist of merely inputting an email address and password as depicted by FIG. 11a, screen shot 1110. If a member belongs to several groups, they may select which group page they would like to go to after login, and will be taken to that page. Upon receiving member information, the member is directed to their group's home page as depicted by FIG. 1d, screen shot 1112. Where the member is granted administrative privileges, they may have the ability to schedule events (screen shot 1108), change contact lists (screen shot 1116), member web pages (screen shot 1118). Where meeting information is received and stored (that is either initially input, updated or edited 1119) as shown in FIG. 1108, an email is automatically generated 1120. As depicted by the contact list screen shot 1116 (FIG. 11h), a contact list may be generated. Information contained within the contact list may be used to generate emails 1122 (FIG. 11h) inviting potential members to join the group. The individual members then input their member information.

A list of items are received and stored in computer readable memory and categorized. For example, “The last time they met” by Anita Shreve may be stored by title and author. It may be categorized as a romance novel or fiction, or any other term known within the art. The item may also be categorized as book selection. Information regarding items may be taken from a multitude of sources without limitation, including other databases, user input and user feedback.

It should be understood, of course, that the foregoing relates to preferred embodiments of the invention and that modifications may be made without departing from the spirit and scope of the invention as set forth in the following claims.

I claim:

1. A system for providing meeting planning services for multiple members of a group via a communications network, the system comprising:
a member module for collecting and storing member information;
a group module for collecting and storing group information relating to the group;
a meeting module for collecting and displaying meeting information relating to future meetings and providing inter-group member communication;
a item module for collecting and storing item information; and
a member interface for mediating communications via the communication network between the members of the group and providing information from said member module, said group module, said meeting module and said item module to provide a list of targeted items for sale to said members.

2. A system as in claim 1, wherein said group is a book club.

3. A system as in claim 1, wherein said meeting module collects and displays information selected from the group consisting of member information, group information and item information.

4. A system as in claim 1, wherein said meeting information is selected from the group consisting of location, time, date, book selection, attendance status, and discussion topics.

5. A system as in claim 1, wherein said member information is selected from the group consisting of first name, last name, email address, mailing address, city, town, state, province, zip code, country, make administrative contact, credit card information, telephone, birthday, membership information and attendance status.

6. A system as in claim 1, wherein said group information is selected from the group consisting of name, city, town, state, province, meeting since date, meeting location, relation of member, meeting frequency, who leads, genre, topic, last book read, attendance status, and desired reading topics.

7. A system as in claim 1, wherein said item information is selected from the group consisting of item name, price, genre, group name and author.

8. A system as in claim 1, wherein said targeted item for sale is selected from the group consisting of a book, electronic book, movie, DVD and compact disc.

9. A system for facilitating discussion group meetings over a network, said system comprising:
a computer readable memory storing at least one group with associated group information, at least one meeting item and member information for at least one member for each said at least one group,
wherein said at least one member has selected a group and said computer readable memory provides a discussion forum, presents at least a portion of said group information and at least one meeting item to said member, automatically emails each said member of a group with information regarding said at least one meeting item for said group upon addition of said meeting item to said computer readable memory and offers a targeted item for sale to said member.

10. A system as in claim 9, wherein said group is a book club.

11. A system as in claim 9, wherein said meeting information is selected from the group consisting of location, time, date, book selection, discussion topics and attendance status.

12. A system as in claim 9, wherein said member information is selected from the group consisting of is selected from the group consisting of first name, last name, email address, mailing address, city, town, state, province, zip code, country, make administrative contact, credit card information, telephone, birthday, membership information and attendance status.

13. A system as in claim 9, wherein said group information is selected from the group consisting of name, city, town, state, province, meeting since date, meeting location, relation of member, meeting frequency, who leads, genre, topic, last book read, desired reading topics and attendance status.

14. A system as in claim 9, wherein said targeted item for sale is selected from the group consisting of a book, electronic book, movie, DVD and compact disc.

15. A method for facilitating discussion group meetings over a network between members of the group, said method comprising the steps of:
receiving and storing in computer readable memory group information for at least one group, wherein each said at least one group has at least one member;
receiving and storing in computer readable memory member information for each said at least one member;
receiving and storing in computer readable memory meeting information;
receiving and storing in computer readable memory a list of items for sale; and
informing each said member of said group said meeting information and offering at least one targeted item for sale, wherein said at least one targeted item for sale is selected according to said group.

16. A method as in claim 15, wherein said group information is selected from the group consisting of name, city, town, state, province, meeting since date, meeting location, relation of member, meeting frequency, who leads, genre, topic, last book read, desired reading topics and attendance status.

17. A method as in claim 15, wherein said member information is selected from the group consisting of first name, last name, email address, mailing address, city, town, state, province, zip code, country, make administrative contact, credit card information, telephone, birthday, administrative contact, membership information and attendance status.

18. A method as in claim 15, wherein said meeting information is selected from the group consisting of location, time, date, book selection, discussion topics, and attendance status.

19. A method as in claim 15, further comprising the steps of:
providing a list of membership plans to said member; and
receiving and storing in computer readable memory a membership selection for each said at least one member.

20. A method as in claim 15, further comprising the steps of:
accepting an attendance status from at least one member.

21. A method as in claim 20, further comprising the step of:
providing a graphical interface that lists said attendance status for at least one member.

22. A method as in claim 15, further comprising the step of:
providing an online discussion forum.

23. A method as in claim 15, further comprising the steps of:
editing said meeting information to provide meeting changes for a group; and
informing each member of said group of said meeting changes.

24. A method as in claim 15, further comprising the steps of:
in response to a single action, sending a request to order at least one said targeted item with associated member information;
receiving said request;
retrieving member information stored in said computer readable medium required to purchase said item;
fulfilling the generated order to provide a purchased item; and
delivering to said purchased item to said member.

25. A method as in claim 24, further comprising the step of:
sending a confirmation email to said member confirming purchase of said purchased item.

26. A method as in claim 15, further comprising the steps of:
providing reminders to at least one member of said group.

27. A method as in claim 15, further comprising the steps of:
providing targeted incentives to said members.

28. A method as in claim 15, further comprising the steps of:
providing each said member with a list of groups from said computer readable memory; and
receiving and storing in computer readable memory a group selection from said member.

29. A method as in claim 15, wherein said targeted item for sale is selected from the group consisting of a book, electronic book, movie, DVD and compact disc.

30. A method for facilitating on and offline discussion group meetings over a network between members of the group, said method comprising the steps of:
receiving and storing in a computer readable memory group information for at least one group;
receiving and storing in computer readable memory member information from at least one member;
providing each said at least one member with a list of groups from said computer readable memory;
receiving and storing in computer readable memory a group selection from said member;
providing a list of membership plans to said member, wherein said membership plans are scaled;
receiving and storing in computer readable memory a membership selection for each said at least one member.
receiving and storing in computer readable memory meeting information;
receiving and storing in computer readable memory a contact list;
receiving and storing in computer readable memory a list of items for sale;
categorizing each said item in said list of items to provide a list of categories for each said item;
informing each said member of said group and said contact list of said meeting information and offering at least one targeted item for sale, wherein said at least one targeted item for sale is selected according to said group and said list of categories and may be purchased in response to a single action; and
providing an online discussion forum.

31. A method as in claim 30, wherein said group information is selected from the group consisting of name, city, town, state, province, meeting since date, meeting location, relation of member, meeting frequency, who leads, genre, topic, last book read, desired reading topics.

32. A method as in claim 30, wherein said member information is selected from the group consisting of first name, last name, email address, mailing address, city, town, state, province, zip code, country, make administrative contact, credit card information, telephone, birthday, membership information and attendance status.

33. A method as in claim 30, wherein said meeting information is selected from the group consisting of location, time, date, book selection, discussion topics,

34. A method as in claim 30, further comprising the steps of:
accepting an attendance status from at least one member.

35. A method as in claim 30, further comprising the step of:
providing a graphical interface that lists said attendance status for at least one member.

36. A method as in claim 30, further comprising the steps of:
editing said meeting information to provide meeting changes for a group; and
informing each member of said group of said meeting changes.

37. A method as in claim 30, further comprising the steps of:
providing reminders to at least one member of said group.

38. A method as in claim 30, further comprising the steps of:
providing targeted incentives to said members.

39. A method as in claim 30, further comprising the steps of:
providing each said member with a list of groups from said computer readable memory; and
receiving and storing in computer readable memory a group selection from said member.

40. A method for facilitating book club discussion group meetings over a network between members of the group, said method comprising the steps of:
receiving and storing in a computer readable memory group information for at least one group;
receiving and storing in computer readable memory member information from at least one member;
providing each said at least one member with a list of groups from said computer readable memory;
receiving and storing in computer readable memory a group selection from said member;
providing a list of membership plans to said member, wherein said membership plans are scaled according to the number of items the member agrees to purchase in the future;
receiving and storing in computer readable memory a membership selection for each said at least one member.
receiving and storing in computer readable memory meeting information;
receiving and storing in computer readable memory a list of items for sale;
categorizing each said item in said list of items to provide a list of categories for each said item;
informing each said member of said group of said meeting information and offering at least one targeted item for sale, wherein said at least one targeted item for sale is selected according to said group and said list of categories and may be purchased in response to a single action; and
providing an online discussion forum.

41. A method as in claim 40, wherein said group information is selected from the group consisting of name, city, town, state, province, meeting since date, meeting location, relation of member, meeting frequency, who leads, genre, topic, last book read, desired reading topics.

42. A method as in claim 40, wherein said member information is selected from the group consisting of first name, last name, email address, mailing address, city, town, state, province, zip code, country, make administrative contact, credit card information, telephone, birthday, membership information and attendance status.

43. A method as in claim 40, wherein said meeting information is selected from the group consisting of location, time, date, book selection, discussion topics,

44. A method as in claim 40, further comprising the steps of:
accepting an attendance status from at least one member.

45. A method as in claim 44, further comprising the step of:
providing a graphical interface that lists said attendance status for at least one member.

46. A method as in claim 40, further comprising the steps of:
editing said meeting information to provide meeting changes for a group; and
informing each member of said group of said meeting changes.

47. A method as in claim 40, further comprising the steps of:
providing reminders to at least one member of said group.

48. A method as in claim 40, further comprising the steps of:
providing targeted incentives to said members.
